(19) United States
(12) Patent Application Publication
(10) Pub. No.: US 2012/0288225 A1
(43) Pub. Date: Nov. 15, 2012

(54) ROTATING DEVICE

(75) Inventor: Mitsuo KODAMA, Fujieda City (JP)

(73) Assignee: ALPHANA TECHNOLOGY CO., LTD., Fujieda-City (JP)

(21) Appl. No.: 13/465,467

(22) Filed: May 7, 2012

(30) Foreign Application Priority Data
May 10, 2011 (JP) JP2011-105024

(51) Int. Cl. F16C 33/10

(52) U.S. Cl. 384/276; 384/397

(57) ABSTRACT

A rotating device suitable for weight saving or thinning while maintaining a shock resistance is provided. The rotating device includes a rotating body having a hub on which a recording disk is to be mounted, and a shaft, and a fixing body including a sleeve, a housing, and a base. A lubricant is present between the rotating body and the fixing body. The sleeve is formed of a sintered metal. The housing has an encircling wall, the flange and the bottom which are integrally formed together by pressing.

### CROSS-REFERENCE TO RELATED APPLICATION

This application claims the benefit of priority based on Japanese Patent Application No. 2011-105024 filed on May 10, 2011, the entire specification, claims and drawings of which are herein incorporated in this specification by reference.

### BACKGROUND OF THE INVENTION

1. Field of the Invention

The present invention relates to a rotating device including a fluid bearing having a sleeve and a housing.

2. Description of the Related Art

Disk drive devices like a hard disk drive are becoming compact and increasing the capacity thereof, and are built in various electronic devices. Such disk drive devices are popularly built in, in particular, portable electronic devices like a laptop computer. Such disk drive devices built in the portable electronic devices require weight saving and thinning advantages for carrying in comparison with the ones built in stationary electronic devices like a desktop PC (Personal Computer).

An example rotating device built in such electronic devices has a cylinder member that retains, in a freely rotatable manner, a shaft rotating together with a hub where recording disks are to be mounted. Such a rotating device generates dynamic pressure which is applied to a fluid in the cylinder member to support the shaft by this dynamic pressure in a non-contact manner (see, for example, JP 2011-8851 A, JP 2010-244626 A, and JP 2006-234161 A).

The rotating device disclosed in JP 2011-8851 A is provided with a flange projected from the outer periphery of a sleeve and an inwardly projecting member projected inwardly of a hub. The flange and the inwardly projecting member act in such a way that the hub is not pulled out in the axial direction when a shock is applied to the rotating device.

A technique of making the rotating device light-weighted is to form the structural element like the sleeve from a sintered metal. A sintered metal is formed by compressing and molding powders mainly composed of a metal, and sintering such powders at a high temperature. Hence, the sintered metal has pores thereinside. As a result, the sintered metal can be light-weighted by what corresponds to the pores. Conversely, the sintered metal has a mechanical strength reduced by what corresponds to such pores.

The inventor of the present invention carried out a simulation for applying a shock to the rotating device of JP 2011-8851 A having the sleeve formed of a sintered metal. As a result, it was confirmed that when a shock was applied to the rotating device, the inwardly projecting member collided with the flange, and the flange was deformed at this time. Moreover, in order to make the rotating device thinner by thinning the flange, the strength of the flange is reduced and thus the shock resistance of the rotating device may be further reduced. Accordingly, the inventor recognized that a suppression of the deformation of the flange was the technical issue for weight saving or thinning of the rotating device.

The present invention has been made in view of such a circumstance, and it is an object of the present invention to provide a rotating device suitable for weight saving or thinning.

### SUMMARY OF THE INVENTION

A first aspect of the present invention provides a rotating device that includes: a rotating body including a hub on which a recording disk is to be mounted, and a shaft with an end being fixed to the hub; a fixing body including a sleeve which encircles the shaft and which freely rotatably supports the shaft, a housing that encircles and fixes the sleeve, and a base that fixes the housing; and a lubricant present successively between the rotating body and the fixing body, the sleeve being formed of a sintered metal, the housing comprising an encircling wall that encircles the sleeve, a flange that protrudes from an end of the encircling wall at the hub side outwardly of a radial direction, and a bottom that blocks off an end of the encircling wall at the base side, the encircling wall, the flange, and the bottom being integrally formed by pressing.

A second aspect of the present invention provides a rotating device that includes: a rotating body including a hub on which a recording disk is to be mounted, and a shaft with an end being fixed to the hub; a fixing body including a sleeve which encircles the shaft and which freely rotatably supports the shaft, a housing that encircles and fixes the sleeve, and a base that fixes the housing; and a lubricant present successively between the rotating body and the fixing body; the housing comprising an encircling wall that encircles the sleeve, the bottom that blocks off an end of the encircling wall at the base side, the encircling wall and the bottom being integrally formed by pressing, and a tier that protrudes inwardly of a radial direction so as to face an end face of the sleeve at the base side in an axial direction with the sleeve being fitted in an inner periphery of the encircling wall, and a space inwardly of the tier in the radial direction configures a reservoir that reserves the lubricant.

Any combination of the above-explained structural elements and replacement of the structural element and technical term of the present invention between a method, an apparatus, and a system, etc, are also effective as an embodiment of the present invention.

According to the present invention, it becomes possible to provide a rotating device suitable for weight saving or thinning.

### BRIEF DESCRIPTION OF THE DRAWINGS

FIG. 1 is a diagram showing a rotating device according to an embodiment of the present invention;

FIG. 2 is a cross-sectional view taken along a line A-A in FIG. 1; and

FIG. 3 is an enlarged cross-sectional view showing the periphery of a housing in FIG. 2 in an enlarged manner.

### DETAILED DESCRIPTION OF THE PREFERRED EMBODIMENT

An explanation will be given of a preferred embodiment of the present invention with reference to the accompanying drawings. The same or similar structural element or member will be denoted by the same reference numeral throughout respective figures, and the duplicated explanation will be omitted accordingly. The dimension of each member in the figure is enlarged or reduced as needed to facilitate understanding for the present invention. Some of the members not important to explain an embodiment of the present invention in the figure will be also omitted. A rotating device of the embodiment is appropriately used as a disk drive device like a hard disk drive on which recording disks are to be mounted and which rotates and drives the recording disks.

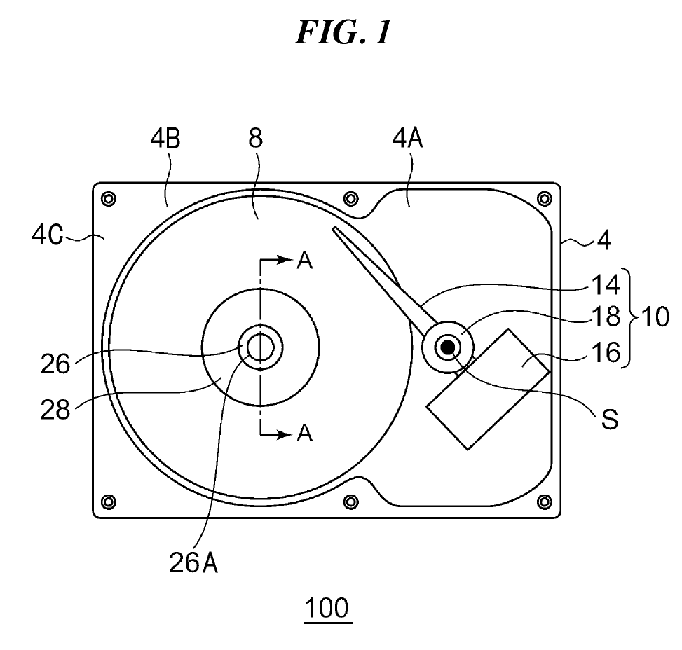

FIG. 1 is a diagram showing a rotating device 100 according to an embodiment. FIG. 1 is also a top view of the rotating device 100 with a top cover (unillustrated) being detached therefrom to expose the internal configuration. The rotating device 100 includes recording disks 8, a hub 28 on which the recording disks 8 are to be mounted, and a shaft 26 fixed to the hub 28. The recording disks 8 rotate together with the rotation of the hub 28. The rotating device 100 also includes a stationary base 4, a data reader/writer 10, the top cover, and a plurality of screws (unillustrated) to fasten the top cover.

In the following explanation, a side where the hub 28 is mounted relative to the base 4 is defined as an upper side.

The recording disk 8 is, for example, a 2.5-inch recording disk formed of a glass and having a diameter of 65 mm. The diameter of the center opening thereof is 20 mm and the thickness of such a disk is 0.65 mm. For example, two recording disks 8 are to be mounted on the hub 28.

The base 4 includes a bottom 4A that forms the bottom part of the rotating device 100, and an outer periphery wall 4B formed along the outer periphery of the bottom 4A so as to surround the area where the recording disks 8 are mounted.

The data reader/writer 10 includes a recording/playing head (unillustrated), a swing arm 14, a voice coil motor 16, and a pivot assembly 18. The recoding/playing head is attached to the tip of the swing arm 14, records data in the recording disks 8, or reads the data therefrom. The pivot assembly 18 supports the swing arm 14 in a swingable manner to the base 4 around a head rotating shaft S. The voice coil motor 16 allows the swing arm 14 to swing around the head rotating shaft S to move the recording/playing head to a desired location over the top face of the recording disk 8. The voice coil motor 16 and the pivot assembly 18 are configured by a conventionally well-known technology of controlling the position of a head.

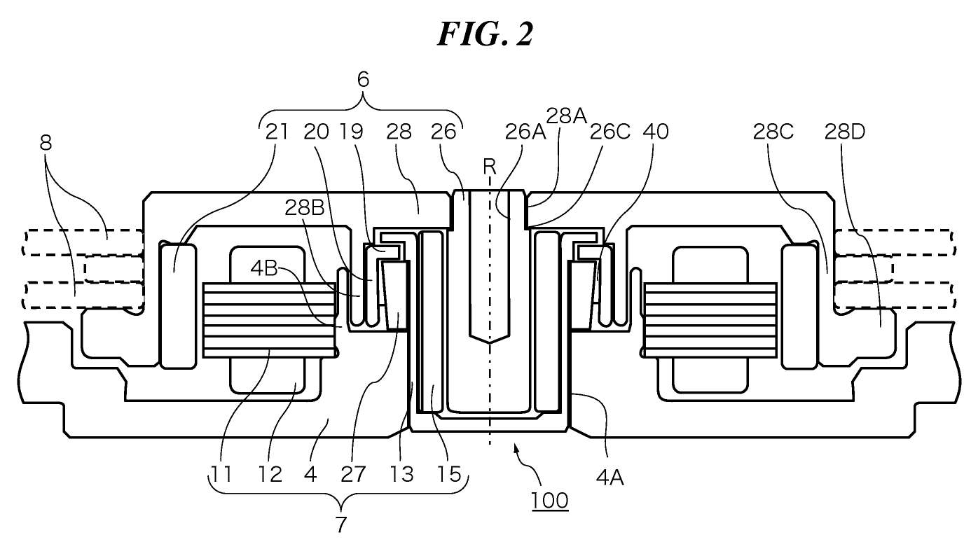

FIG. 2 is a cross-sectional view taken along a line A-A in FIG. 1. The rotating device 100 includes a stationary fixed body 7, a rotating body 6 that rotates relative to the fixed body 7, and a lubricant 40 present between the fixed body 7 and the rotating body 6. The fixed body 7 includes the base 4, a housing 13, a sleeve 15, a stator core 11, coils 12, and a stationary ring member 27. The coils 12 are wound around the stator core 11. The rotating body 6 includes the shaft 26, the hub 28, a disk member 19, a cylindrical member 20, and a magnet 21. In the following explanation, in order to simplify the explanation, with reference to the base 4 in FIG. 2, the direction in which the hub 28 is provided is defined as an upper side, and the opposite direction thereto is defined as a bottom side throughout the following explanation.

The base 4 has a bearing opening 4A formed at the center thereof, and a cylinder part 4B surrounding the bearing opening 4A. The base 4 supports the housing 13 that is fixed in the bearing opening 4A. The stator core is bonded and fixed to the outer periphery of the cylinder part 4B that encircles the housing 13. The base 4 is formed by cutting an aluminum die-cast. The base 4 may be formed by pressing an aluminum plate or a steel plate on which nickel plating is applied. The base 4 may be formed of other materials or through other manufacturing techniques to meet the desired specification.

The stator core 11 is formed by stacking magnetic materials like silicon steel plates. An insulative coating by electrodeposition coating or powder coating, etc., is applied on the surface of the stator core 11. The stator core 11 has an annular part and nine protrusions (unillustrated) protruding outwardly from the annular part. The number of protrusions of the stator core 11 can be other numbers so as to meet the desired specification. The coil 12 is wound around each protrusion. The end of winding of the coil 12 is coupled to a predetermined drive circuit (unillustrated) provided on the bottom face of the base 4. A three-phase substantially sine-wave current is supplied to the coils 12 from the drive circuit.

The hub 28 includes a center opening 28A provided in the center thereof, an internal cylinder part 28B provided so as to surround the center opening 28A, an external cylinder part 28C disposed outwardly of the internal cylinder part 28B, and a hub externally extending part 28D extending to the exterior in the radial direction of the hub 28 from the lower end of the external cylinder part 28C. The hub 28 is formed in a substantially cup shape. The hub 28 has a soft magnetic property. The hub 28 is formed of an iron-and-steel material like JIS SUS430F. The hub 28 is formed by pressing or cutting an iron-and-steel plate. The hub 28 may be formed of other materials or through other manufacturing techniques to meet the desired specification. The center opening of the recording disk 8 is engaged with the outer periphery of the external cylinder part 28C of the hub 28. The recording disk 8 is mounted on the hub externally extending part 28D of the hub 28.

The shaft 26 is formed in a substantially columnar shape. The shaft 26 is formed of a stainless-steel material like JIS SUS420J2. The shaft 26 may be formed of other materials to meet the desired specification. A screw hole 26A is formed in the upper end of the shaft 26. A screw passing all the way through the center opening of a clamper (unillustrated) is threaded in the screw hole 26A, and thus the clamper is fixed to the upper end of the shaft 26. The outer periphery of the clamper holds the recording disk 8. The shaft 26 is fixed in the center opening 28A of the hub 28 by interference fitting. The shaft 26 may be fixed by other manufacturing techniques like bonding to meet the desired specification. The shaft 26 has a tier 26C provided at the upper end thereof like a step. The lower edge of the center opening 28A of the hub 28 is fixed so as to contact the tier 26C. The tier 26C restricts the movement of the hub 28 in the axial direction. Note that the axial direction is a direction along a rotational axis R. The hub 28 is joined together with the shaft 26 at a predetermined squareness. The tip portion of the shaft 26 is retained in an inner periphery 15A of the sleeve 15.

The magnet 21 is formed in a substantially ring shape. The magnet 21 is formed of an Nd—Fe—B (neodymium-iron-boron) based material. An electrodeposition coating or a spray painting is applied on the surface of the magnet 21. The magnet 21 is bonded and fixed to the inner periphery of the external cylinder part 28C of the hub 28. The magnet 21 has 12 magnetic poles at the inner periphery thereof. The number of magnetic poles of the magnet 21 may be other numbers to meet the desired specification. The magnet 21 encircles the outer periphery of the stator core 11 fixed to the base 4. There is a clearance between the inner periphery of the magnet 21 and the outer periphery of the stator core 11. Such a clearance is, for example, 0.2 to 0.8 mm.

When a current is supplied to the coils 12 from the drive circuit, respective protrusions of the stator core 11 produce drive magnetic fields. Rotational driving force is produced by the mutual action of the drive magnetic fields and the magnetic fields of the magnetic poles of the magnet 21. The rotational driving force rotates the hub 28 together with the shaft 26. The hub 28 rotates the recording disks 8.

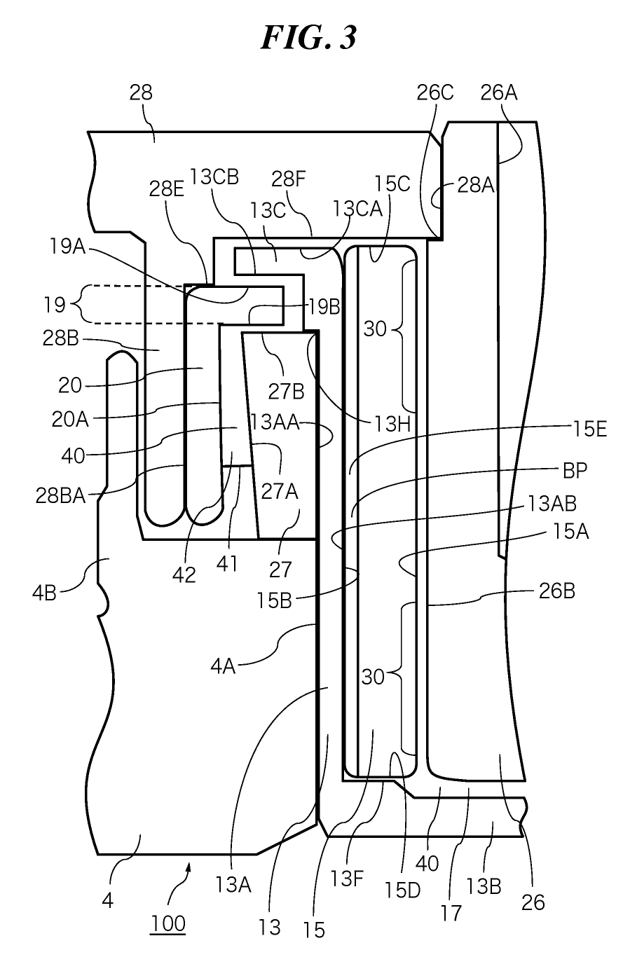

FIG. 3 is a cross-sectional view of the periphery of the housing 13 shown in FIG. 2 in an enlarged manner.

The sleeve 15 is formed in a cylindrical shape. The sleeve 15 is fixed to an inner periphery 13AB of the housing 13 by bonding or press-fitting. The sleeve 15 has the inner periphery 15A that retains the shaft 26. The sleeve 15 has a radial dynamic pressure generating groove 30 formed in the inner periphery 15A. The radial dynamic pressure generating groove 30 may be formed in an outer periphery 26B of the shaft 26 instead of the inner periphery 15A of the sleeve 15. As the shaft 26 and the sleeve 15 rotate relative to each other, the radial dynamic pressure generating groove 30 generates radial dynamic pressure applied to the lubricant 40. The radial dynamic pressure generating groove 30 is formed in a herringbone shape. The radial dynamic pressure generating groove 30 may be formed in other shapes like a spiral shape. The sleeve 15 is formed by sintering powders mainly composed of metals. According to this embodiment, the sleeve 15 is formed by sintering powders mainly composed of iron, and forming a coating layer of trivalent-iron tetroxide on the surface of the sintered material. More specifically, the sleeve 15 is formed through powder metallurgy processes, and is disposed in water vapor at a high temperature to form an oxide film. It is advantageous for facilitating the mass-production of the sleeve with the same shape of the highly precise dimension. The sleeve 15 may be formed of other materials or through other manufacturing techniques to meet the desired specification.

The housing 13 retains at least a part of the sleeve 15. The housing 13 has an encircling wall 13A, a bottom 13B and a flange 13C. The encircling wall 13A encircles the sleeve 15. The bottom 13B blocks off the lower end of the encircling wall 13A. The flange 13C protrudes outwardly of the radial direction from an end of the encircling wall 13A at the hub-28 side. According to this embodiment, the housing 13 is formed in such a way that the encircling wall 13A, the bottom 13B and the flange 13C are integrally formed by pressing a stainless-steel plate of JIS SUS303. The housing 13 may be formed of other materials or through other manufacturing techniques to meet the desired specification. The housing 13 may be formed by pressing a metal plate and cutting the pressed metal plate. A desired shape can be obtained with a high precision. Moreover, electroless nickel plating, etc., may be applied on the surface of the housing 13. The housing 13 is bonded and fixed to the bearing opening 4A of the base 4.

According to this embodiment, the rotating device 100 further includes the stationary ring member 27 and the disk member 19. The stationary ring member 27 is formed in a substantially ring shape, and is fixed so as to encircle at least a part of the housing 13. The stationary ring member 27 is bonded and fixed to an outer periphery 13AA of the encircling wall 13A. The stationary ring member 27 may be fixed through other techniques like interference fitting. A space is formed between an upper face 27B of the stationary ring member 27 and a lower face 13CB of the flange 13C. The disk member 19 rotates together with the hub 28 in this space. The stationary ring member 27 can be formed of a metallic material or a resin material. For example, the stationary ring member 27 can be formed by cutting a stainless-steel material. The stationary ring member 27 may be formed of the same material as that of the housing 13. An outer periphery 27A of the stationary ring member 27 has a diameter gradually reduced toward the bottom.

The cylindrical member 20 is formed in a substantially cylindrical shape. The cylindrical member 20 is bonded and fixed to an inner periphery 28BA of the internal cylinder part 28B of the hub 28. An inner periphery 20A of the cylindrical member 20 has a diameter gradually reduced toward the bottom. The cylindrical member 20 is formed by cutting a stainless-steel material like JIS SUS303 or SUS430F. The cylindrical member 20 may be formed of other metallic or resin materials or through other manufacturing techniques to meet the desired specification.

Formed between the cylindrical member 20 and the stationary ring member 27 is a capillary seal 42 that is a space between the outer periphery 27A and the inner periphery 20A and gradually expanding toward the bottom. The capillary seal 42 suppresses a leak-out of the lubricant 40 by a capillary phenomenon. The stationary ring member 27 and the cylindrical member 20 have an air-liquid interface 41 of the lubricant 40 provided between the outer periphery 27A and the inner periphery 20A. The air-liquid interface 41 of the lubricant 40 contacts the outer periphery 27A of the stationary ring member 27 and the inner periphery 20A of the cylindrical member 20. An oil-repelling agent is applied around the outlet of the capillary seal 42. The leaked lubricant 40 is repelled by the oil-repelling agent, and returns to the air-liquid interface 41, thereby suppressing depletion of the lubricant 40.

The disk member 19 is bonded and fixed to the inner periphery 28BA of the internal cylinder part 28B of the hub 28. The disk member 19 rotates together with the hub 28 in a space below the flange 13C toward the base 4. A part of the upper face 19A of the disk member 19 contacts a lower face 28E of the hub 28. The disk member 19 is formed integral with the cylindrical member 20 by cutting a stainless-steel material like JIS SUS303 or SUS430F. The disk member 19 may be formed of other metallic or resin materials or through other manufacturing techniques to meet the desired specification. The disk member 19 and the cylindrical member 20 may be formed as separate pieces. Moreover, the disk member 19 and the cylindrical member 20 may be separately fixed to the hub 28.

A thrust dynamic pressure generating groove that generates thrust dynamic pressure is formed in at least any one of a lower face 28F of the hub 28 at the base-4 side, an upper face 13CA of the flange 13C at the hub-28 side, a lower face 13CB of the flange 13C at the base-4 side, the upper face 19A of the disk member 19 at the hub-28 side, a lower face 19B of the disk member 19 at the base-4 side, and an upper face 27B of the stationary ring member 27 at the hab-28 side. The thrust dynamic pressure generating groove is formed in a spiral shape. The thrust dynamic pressure generating groove may be in other shapes like a herringbone shape. The thrust dynamic pressure generating groove produces dynamic pressure in the thrust direction applied to the lubricant 40. The thrust dynamic pressure supports the rotating body 6 in the thrust direction relative to the fixed body 7 in a non-contact manner.

The rotating device 100 includes a communicated passage BP that communicates an upper end face 15C of the sleeve 15 with a lower end face 15D thereof. The communicated passage BP is filled with the lubricant 40. The communicated passage BP reduces a difference in pressure between the upper end face 15C of the sleeve 15 and the lower end face 15D thereof. The communicated passage BP is formed as a groove 15E in an outer periphery 15B of the sleeve 15 in the axial direction. The communicated passage BP may be formed as an aperture that passes all the way through the sleeve 15 up and down. The internal surface of the communicated passage BP may be corroded and swell. Depending on such swelling, the communicated passage BP may be clogged in the worst case. In order to address this technical issue, a surface treatment for suppressing corrosion is applied to the internal surface of the communicated passage BP. According to this embodiment, the sleeve 15 is formed of a sintered metal mainly composed of iron, and the coating of trivalent-iron tetroxide is formed on the surface of the groove 15E.

Since the sleeve 15 is a sintered material, the sleeve 15 may contain thereinside pores communicated with the exterior through the surface. When the sintered material expands due to a temperature rise, such pores also expand and may suction the lubricant 40 adhered to the surface of the sleeve 15. As a result, the amount of the lubricant 40 present around the radial dynamic pressure generating groove 30, etc., decreases. When the amount of the lubricant 40 decreases, generation of dynamic pressure becomes unstable, which may disturb the normal rotating operation of the rotating body 6. In order to address this technical issue, a reservoir 17 for the lubricant 40 is provided in the housing 13. Since the total amount of the lubricant 40 present between the rotating body 6 and the fixed body 7 increases, the negative effect by the suction of the lubricant 40 by the sleeve 15 becomes relatively small. More specifically, the inner periphery 13AB of the encircling wall 13A of the housing 13 is provided with a tier 13F that is like a step which protrudes inwardly of the radial direction so as to face the lower end face 15D of the sleeve 15 in the axial direction with the sleeve 15 being inserted. The area of the tier 13F inwardly of the radial direction forms the reservoir 17 that reserves the lubricant 40. The tier 13F can be formed by plastic processing like pressing. When the tier 13F is successively formed by processing the housing 13 after the encircling wall 13A is formed, the process effort can be little. The tier 13F may be formed in such a manner as to contact at least a portion of the lower end face 15D. This facilitates the positioning of the sleeve 15 in the axial direction.

When the upper face 27B of the stationary ring 27 is too close to the lower face 13CB of the flange 13, the upper face 27B may contact the lower face 19B of the disk member 19, which may disturb the normal rotating operation.

In order to address this technical issue, means for restricting the movement of the stationary ring 27 in the axial direction is provided. More specifically, the encircling wall 13A of the housing 13 has a protrusion 13H provided on the outer periphery of the encircling wall 13A and protruding outwardly of the radial direction. The protrusion 13H of the housing 13 contacts the upper face 27B of the stationary ring 27 at the hub-28 side with the housing 13 being fitted in the stationary ring 27. The protrusion 13H is formed by plastic processing like pressing. When the protrusion 13H is successively processed and formed after the encircling wall 13A is formed, the process effort can be little.

If the fitting resistance when the sleeve 15 is fitted in the inner periphery 13AB of the encircling wall 13A is too large, the sleeve 15 may be fixed in a tilted manner. In order to address this technical issue, the inner periphery 13AB of the encircling wall 13A is provided with means for reducing the fitting resistance. More specifically, the inner periphery 13AB of the encircling wall 13A of the housing 13 has an inclination that gradually increases the diameter toward the hub 28. As a result, the fitting resistance of the sleeve 15 becomes small, and thus the tilting of the sleeve 15 can be suppressed.

Moreover, when the surface roughness of the inner periphery 13AB of the encircling wall 13A in the circumferential direction is small, the sleeve 15 in the encircling wall 13A may have a small rotational strength. When such a rotational strength is small, the sleeve 15 may be ejected from the encircling wall 13A, which may disturb the normal rotating operation. Conversely, if the surface roughness of the inner periphery 13AB in the axial direction is large, the fitting resistance of the sleeve 15 becomes large, resulting in the tilted fixing of the sleeve 15 in some cases. That is, it is desirable that the surface roughness should be large in the rotational direction but be small in the axial direction. Hence, according to this embodiment, the inner periphery 13AB of the encircling wall 13A is formed to have a smaller surface roughness measured in the axial direction than the surface roughness measured in the circumferential direction. As a result, it becomes possible to decrease the fitting resistance of the sleeve 15 while suppressing the reduction of the rotational strength of the sleeve 15.

According to this embodiment, the inner periphery 13AB of the encircling wall 13A is formed to have a smaller surface roughness measured in the axial direction than the surface roughness of the upper face of the bottom 13B at the hub-28 side measured in the circumferential direction.

When the thickness of the bottom 13B of the housing is too thin, in manufacturing the rotating device 100, if the bottom 13B hits the manufacturing facilities, etc., the bottom 13B is likely to be deformed. When the bottom 13B of the encircling wall 13A deforms, it may disturb the normal rotating operation. Conversely, when the thickness of the encircling wall 13A of the housing 13 is too thick, the external dimension of the rotating device increases by what corresponds to such thickness. Hence, according to this embodiment, the housing 13 is formed in such a way that the thickness dimension of the bottom 13B in the axial direction is larger than the thickness dimension of the encircling wall 13A in the radial direction. It becomes possible to reduce the possibility that the bottom 13B is deformed, while at the same time, to suppress the increase of the external dimension of the rotating device. Note that the term the thickness dimension in the radial direction of the encircling wall 13A means a thickness dimension in the radial direction of a portion other than the protrusion 13H.

When the thickness of the flange 13C of the housing 13 is too thin, if the flange 13C hits the hub 28, the flange 28 is likely to be deformed. When the flange 13C is deformed, it may disturb the normal rotating operation. Hence, according to this embodiment, the housing 13 is formed in such a way that the flange 13C has the thickness dimension in the axial direction larger than the thickness dimension of the encircling wall 13A in the radial direction. This reduces the possibility that the flange 13C is deformed.

When the thickness of the encircling wall 13A of the housing 13 is too thick, the external dimension of the rotating device increases by what corresponds to such thickness. Conversely, when the external dimension of the rotating device is constant, it is typical that the periphery wall of the sleeve 15 is formed to be thin. If such a periphery wall is thin, when the sleeve 15 is fitted in the housing 13, the radial dynamic pressure generating groove 30 formed in the inner periphery 15A of the sleeve 15 may be deformed. Hence, according to this embodiment, the housing 13 is formed in such a way that the encircling wall 13A has the smaller thickness dimension in the radial direction than the thickness dimension of the sleeve 15 in the radial direction. This suppresses the deformation of the radial dynamic pressure generating groove 30.

When the thickness of the encircling wall 13A is thin, the housing 13 may be deformed when fitted in the bearing opening 4A of the base 4. Hence, according to this embodiment, the housing 13 is formed in such a way that the encircling wall 13A is harder than the bottom 13B. Moreover, the housing 13 has the encircling wall 13A formed so as to be harder than the sleeve 15. For example, machining can be carried out by applying larger stress to the encircling wall 13A than stress applied to the bottom 13B. This can reduce the possibility of the deformation of the encircling wall 13A.

Next, an explanation will be given of example processes of manufacturing the housing 13.

First of all, a pressing device having progressive dies with multiple stages is prepared. The dies include, for example, a die, a punch, and a blank holder, and are separable in the vertical direction. Moreover, a stripe material (blank) is prepared. This material is formed of, for example, JIS SUS303 stainless steel. The stripe material is successively pressed at respective stages of progressive dies.

Next, an appropriate amount of a machining oil is applied to the stripe material, the stripe material is placed between the upper and lower dies, and portions to be the encircling wall 13A and the bottom 13B are formed by, for example, drawing. The plurality of stages are provided for drawing, and drawing can be performed at each stage up to a depth shorter than the outer diameter of the encircling wall 13A. It is fine if drawing at each stage is performed up to a depth that is, for example, substantially half of the outer diameter of the encircling wall 13A. By repeating the drawing, the encircling wall 13A with a predetermined depth dimension can be formed.

By increasing the number of drawing, the deformation amount of the stripe material increases by what corresponds to the increase of the number of drawings, and thus the working strength increases. Accordingly, the encircling wall 13A can be formed harder. Because of the large working strength, even if a thin material, a tough work can be formed in accordance with such a large working strength. In other words, since a tough work can be formed from a thin material, it results in weight saving, and thus the rotating device can be light-weighted as a whole. The number of drawing can be set to accomplish a predetermined level of hardness of the encircling wall 13A.

Moreover, by increasing the number of drawing, the surface roughness of the encircling wall 13A in the axial direction can be reduced. Hence, the number of drawing can be set to accomplish a predetermined level of the surface roughness of the encircling wall 13A in the axial direction.

Furthermore, by increasing the number of drawing, the encircling wall 13A can have a thickness dimension small in the radial direction. Hence, the number of drawing can be set to accomplish a predetermined thickness dimension of the encircling wall 13A in the radial direction.

Moreover, in another stage, the tier 13F that is like a step protruding inwardly of the radial direction is formed into a predetermined shape at a boundary between the encircling wall 13A and the bottom 13B by stamping. Likewise, in the other stage, the protrusion 13H protruding outwardly of the radial direction is formed in a predetermined shape on the outer periphery of the encircling wall 13A by drawing. The protrusion 13H may be formed in a drawing stage for forming the encircling wall 13A. In the further other stage, the flange 13C is formed into a predetermined shape by stamping. In the final stage, the outer periphery of the flange 13C is cut from the stripe material, and thus the housing 13 is formed.

The housing 13 cut out from the material may be subjected to a surface treatment like polishing as needed. By performing the polishing, fine concavity and convexity on the surface can be eliminated, or the dimension accuracy can be improved.

As explained above, by forming the housing 13 through pressing, the housing 13 having a high strength can be formed using a thin material, resulting in an accomplishment of weight saving of the rotating device.

The above-explanation was given of the case in which the housing is successively processed, but the present invention is not limited to this case.

For example, a so-called transfer processing may be performed which cuts out a portion to be a product from the stripe material at first, and which performs drawing multiple times while moving the cut portion to a plurality of dies.

The configuration of the rotating device 100 and the operation thereof according to the embodiment were explained above. It should be understood by those skilled in the art that such an embodiment is to exemplify the present invention, and various modifications and changes can be made to the combination of respective structural elements, and such modifications and changes are also within the scope and spirit of the present invention.

In the above-explained embodiment, the explanation was given of a so-called outer-rotor rotating device having the magnet 21 disposed outwardly of the stator core 11, but the present invention is not limited to this configuration. For example, the present invention can be applied to a so-called inner-rotor rotating device having the magnet disposed inwardly of the stator core.

In the above-explained embodiment, the explanation was given of the case in which a core stacked on the stator core 11 is used, but the core is not limited to the stacked core.

What is claimed is:

1. A rotating device comprising:
a rotating body including a hub on which a recording disk is to be mounted, and a shaft with an end being fixed to the hub;
a fixing body including a sleeve which encircles the shaft and which freely rotatably supports the shaft, a housing that encircles and fixes the sleeve, and a base that fixes the housing; and
a lubricant present successively between the rotating body and the fixing body,
the sleeve being formed of a sintered metal,
the housing comprising an encircling wall that encircles the sleeve, a flange that protrudes from an end of the encircling wall at the hub side outwardly of a radial direction, and a bottom that blocks off an end of the encircling wall at the base side, the encircling wall, the flange, and the bottom being integrally formed by pressing.

2. The rotating device according to claim 1, wherein
the fixing body further includes a stationary ring member that is fixed so as to encircle the housing,
the rotating body further includes a disk member that rotates together with the hub in a space between the flange and the stationary ring member in an axial direction, and
an air-liquid interface of the lubricant contacts an outer periphery of the stationary ring member.

3. The rotating device according to claim 2, wherein
the rotating body further includes a cylindrical member which encircles the housing and which rotates together with the hub, and
the air-liquid interface of the lubricant also contacts an inner periphery of the cylindrical member.

4. The rotating device according to claim 1, further comprising a groove formed in an outer periphery of the sleeve in a direction along a rotational axis,
wherein a coating layer of trivalent-iron tetroxide is formed on a surface of the groove.

5. The rotating device according to claim 1, wherein
the housing is provided with a tier that protrudes inwardly of the radial direction so as to face an end face of the sleeve at the base side in an axial direction with the sleeve being fitted in an inner periphery of the encircling wall, and
an area inwardly of the tier in the redial direction configures a reservoir that reserves the lubricant.

6. The rotating device according to claim 2, wherein the housing is provided with a protrusion protruding outwardly of the radial direction so as to be engaged with an upper face of the stationary ring at the hub side with the stationary ring being fitted to an outer periphery of the encircling wall.

7. The rotating device according to claim 1, wherein the housing is formed so that a surface roughness of an inner periphery of the encircling wall measured in an axial direction becomes smaller than a surface roughness measured in a circumferential direction.

8. The rotating device according to claim 1, wherein the housing is formed so that a thickness dimension of the bottom in an axial direction becomes larger than a thickness dimension of the encircling wall in the radial direction.

9. The rotating device according to claim 1, wherein the housing is formed so that a thickness dimension of the encircling wall in the radial direction becomes smaller than a thickness dimension of the sleeve in the radial direction.

10. The rotating device according to claim 1, wherein the housing is formed so that the encircling wall becomes harder than the bottom.

11. A rotating device comprising:
a rotating body including a hub on which a recording disk is to be mounted, and a shaft with an end being fixed to the hub;
a fixing body including a sleeve which encircles the shaft and which freely rotatably supports the shaft, a housing that encircles and fixes the sleeve, and a base that fixes the housing; and
a lubricant present successively between the rotating body and the fixing body;
the housing comprising an encircling wall that encircles the sleeve, a bottom that blocks off an end of the encircling wall at the base side, the encircling wall and the bottom being integrally formed by pressing, and a tier that protrudes inwardly of a radial direction so as to face an end face of the sleeve at the base side in an axial direction with the sleeve being fitted in an inner periphery of the encircling wall, and
a space inwardly of the tier in the radial direction configures a reservoir that reserves the lubricant.

12. The rotating device according to claim 11, wherein
the fixing body further includes a stationary ring member that is fixed so as to encircle the housing, and
an air-liquid interface of the lubricant contacts an outer periphery of the stationary ring member.

13. The rotating device according to claim 12, wherein
the rotating body further includes a cylindrical member which encircles the housing and which rotates together with the hub, and
the air-liquid interface of the lubricant also contacts an inner periphery of the cylindrical member.

14. The rotating device according to claim 11, further comprising a groove formed in an outer periphery of the sleeve in a direction along a rotational axis,
wherein a coating layer of trivalent-iron tetroxide is formed on a surface of the groove.

15. The rotating device according to claim 11, wherein the sleeve is formed of a sintered metal.

16. The rotating device according to claim 12, wherein the housing is provided with a protrusion protruding outwardly of the radial direction so as to be engaged with an upper face of the stationary ring at the hub side with the stationary ring being fitted to an outer periphery of the encircling wall.

17. The rotating device according to claim 11, wherein the housing is formed so that a surface roughness of the inner periphery of the encircling wall measured in an axial direction becomes smaller than a surface roughness measured in a circumferential direction.

18. The rotating device according to claim 11, wherein the housing is formed so that a thickness dimension of the bottom in an axial direction becomes larger than a thickness dimension of the encircling wall in the radial direction.

19. The rotating device according to claim 11, wherein the housing is formed so that a thickness dimension of the encircling wall in the radial direction becomes smaller than a thickness dimension of the sleeve in the radial direction.

20. The rotating device according to claim 11, wherein the housing is formed so that the encircling wall becomes harder than the bottom.
